(19) United States
(12) Patent Application Publication
(10) Pub. No.: US 2006/0119265 A1
(43) Pub. Date: Jun. 8, 2006

(54) Rear plate for plasma display panel

(76) Inventor: Won-Duk Cho, Gyeongsang buk-do (KR)

Correspondence Address: BIRCH STEWART KOLASCH & BIRCH, PO BOX 747, FALLS CHURCH, VA, 22040-0747, US

(21) Appl. No.: 10/537,762

(22) PCT Filed: Dec. 7, 2002
(86) PCT No.: PCT/KR02/02305

§ 371 Date: Jun. 6, 2005

(30) Foreign Application Priority Data
Dec. 6, 2002 (KR) 10-2002-0077251

(51) Int. Cl. H01J 17/49

(52) U.S. Cl. 313/582

(57) ABSTRACT

Disclosed is a rear plate of a plasma display panel. In the rear plate, barrier ribs are formed through etching after backing, and thus the completed barrier ribs are not deformed. Therefore, each electrode can be exactly located on a central portion between barrier ribs. When a PDP having front and rear plates attached to each other has been completed, optical characteristics of the PDP such as white brightness, color temperature, and contrast, and electric characteristics of the PDP such as voltage margin, power consumption, and electric efficiency, are improved, so that the reliability is improved.

### TECHNICAL FIELD

The present invention relates to a rear plate of a plasma display panel.

### BACKGROUND ART

As generally known in the art, a plasma display panel (PDP) is a display device having a front glass substrate and a rear glass substrate between which a discharge space is formed, so that plasma discharge may generate in the discharge space, thereby causing phosphors in the discharge space to be excited and emit light, so as to display a screen.

PDPs may be classified into direct current plasma display panels (DC PDPs) and alternating current plasma display panels (AC PDPs), from among which the AC PDPs are the mainstream. U.S. Pat. No. 5,446,344 discloses a three-electrode surface-discharge alternating-current plasma display panel which is one of the representative AC PDPs.

A PDP includes a front plate and a rear plate assembled in parallel with each other. The front plate includes a front glass substrate, transparent electrodes formed on a lower surface of the front glass substrate, each of the transparent electrodes including a scan electrode and a sustain electrode, bus electrodes formed on lower surfaces of the transparent electrodes so as to reduce resistance of the transparent electrodes, a dielectric layer covering the transparent electrodes and the bus electrodes, and a magnesium oxide layer formed on a lower surface of the dielectric layer so as to prevent sputtering of the dielectric layer and facilitate discharge of secondary electrons. Further, the rear plate includes a rear glass substrate, address electrodes, a dielectric layer, barrier ribs for forming discharge compartments between the front and rear plates, and phosphorous layers.

In general, a rear plate of a PDP as described above is manufactured by sand blasting similar to a method of forming a thick film of a substrate of a PDP, which is disclosed by Japanese Patent Laid-Open No. P5-128966.

In the conventional rear plate manufactured using the sand blasting as described above, barrier ribs are preliminary formed by sand blasting and are then completed through firing. As a result, in the course of the firing process, the barrier ribs may be distorted and deformed. Therefore, it is difficult to exactly locate each electrode on a central position between two barrier ribs, which is a desired position for each electrode.

### DISCLOSURE OF THE INVENTION

Therefore, the present invention has been made in view of the above-mentioned problems, and it is an object of the present invention to provide a rear plate of a plasma display panel, in which, not only can each electrode exactly be located on a central portion between barrier ribs, but also can various characteristics of a PDP be improved.

According to an aspect of the present invention, there is provided a rear plate of a plasma display panel, the rear plate comprising: a glass substrate; electrodes formed on an upper surface of the glass substrate; a dielectric layer formed on upper surfaces of the electrode and the upper surface of the glass substrate; barrier ribs formed in a shape of a pattern through etching on an upper surface of the dielectric layer; and phosphorous layers formed on side surfaces and bottom surfaces of the barrier ribs and including red, green, and blue phosphorous layers, which emit red, green, and blue light according to an electric signal, respectively, wherein: the electrodes are made from mixture of a conductive metal powder of 51 to 99.5 wt % and a first glass powder of 0.5 to 49 wt %, the conductive metal powder being at least one metal powder selected from metal powders of An, Ag, Pt, Pd, Ni, and Cu, the conductive metal powder having an average particle diameter of 0.1 to 7 μm, the first glass powder having an average particle diameter of 0.5 to 10 μm and a specific resistance of 1.0×10⁻⁶ to 5.0×10⁻⁶ Ωcm; the dielectric layer is made from mixture of a first filler and at least one glass powder selected from among a second glass powder and a third glass powder, the second glass powder including PbO of 30 to 80 wt %, ZnO of 0 to 20 wt %, SiO₂ of 0 to 20 wt %, B₂O₃ of 5 to 40 wt %, Al₂O₃ of 0 to 12 wt %, Na₂O+K₂O+Li₂O of 0 to 5 wt %, and BaO+CaO+MgO+SrO of 0 to 5 wt %, the third glass powder including Bi₂O₃ of 36 to 84 wt %, B₂O₃ of 5 to 28 wt %, PbO of 0 to 46 wt %, ZnO of 0 to 30 wt %, Al₂O₃ of 0 to 13 wt %, SiO₂ of 0 to 10 wt %, Na₂O+K₂O+Li₂O of 0 to 5 wt %, and BaO+CaO+MgO+SrO of 0 to 3 wt %, each of the second and third glass powders having an average particle diameter of 0.5 to 10 μm, a softening temperature of 390 to 550° C., a thermal expansive coefficient of 63×10⁻⁷ to 83×10⁻⁷/° C., a dielectric constant of 11 to 26, and an etching rate of 0.1 to 1.0 μm/min, the first filler having an average particle diameter of 0.5 to 10 μm and including at least one oxide selected from the group consisting of TiO₂, ZrO₂, ZnO, Al₂O₃, BN, SiO₂, and MgO, which are white oxides, a ratio of volume of the first filler with respect to volume of the glass powder in the dielectric layer being 0.05 to 0.30, thereby the dielectric layer having a dielectric constant of 11 to 26, a reflectance of 50 to 80%, an etching rate of 0.1 to 1.0 μm/min, and a porosity of 5, when the dielectric layer has been baked for 10 to 60 minutes at 450 to 600° C.; the barrier ribs are made from mixture of at least one glass powder selected from the group consisting of the fourth, fifth, and sixth glass powders and at least one filler selected from the group consisting of a second filler and a third filler, the fourth glass powder including ZnO of 0 to 48 wt %, SiO₂ of 0 to 21 wt %, B₂O₃ of 25 to 56 wt %, Al₂O₃ of 0 to 12 wt %, Na₂O+K₂O+Li₂O of 0 to 38 wt %, and BaO+CaO+MgO+SrO of 0 to 15 wt %, the fifth glass powder including PbO of 25 to 65 wt %, ZnO of 0 to 35 wt %, SiO₂ of 0 to 26 wt %, B₂O₃ of 5 to 30 wt %, Al₂O₃+SnO₂ of 0 to 13 wt %, Na₂O+K₂O+Li₂O of 0 to 19 wt %, BaO of 0 to 26 wt %, and CaO+MgO+SrO of 0 to 13 wt %, the sixth glass powder including PbO of 35 to 55 wt %, B₂O₃ of 18 to 25 wt %, ZnO of 0 to 35 wt %, BaO of 0 to 16 wt %, SiO₂+Al₂O₃+SnO₂ of 0 to 9 wt %, CoO+CuO+MnO₂+Fe₂O₃ of 0 to 15 wt %, Na₂O+K₂O+Li₂O of 0 to 19 wt %, and CaO+MgO+SrO of 0 to 13 wt %, each of the fourth, fifth, and sixth glass powders has an average particle diameter of 0.5 to 10 μm, a softening temperature of 390 to 630° C., a thermal expansive coefficient of 63×10⁻⁷ to 83×10⁻⁷/° C., a dielectric constant of 5 to 20, and an etching rate of 2.0 to 50.0 μm/min, the second filler including at least two oxides selected from the group consisting of NiO, Fe₂O₃, CrO, MnO₂, CuO, Al₂O₃, and SiO₂, which have dark colors, the third filler including at least one oxide selected from the group consisting of TiO₂, ZrO₂, ZnO, Al₂O₃, BN, SiO₂, and MgO, which have white colors, each of the second and third fillers having an average particle diameter of 0.1 to 10 μm, a ratio of the volume of the filler with respect to the volume of the glass powder for the barrier ribs being 0.05 to 0.67, thereby the barrier ribs having a dielectric constant of 5 to 16 and an etching rate of 2 to 50 μm/min and enabling the glass substrate having the barrier ribs to have a bending of at most 0.3 mm, when the barrier ribs has been baked for 10 to 60 minutes at 450 to 600° C., the barrier ribs having a height difference of at most 1% when the barrier ribs has been baked at 510° C. for one hour after being etched by acid-based etching solution, the barrier ribs having a destruction ratio of 50% when an iron rod, which weighs 500 g and has an end portion shaped like a sphere having a radius of 3 mm, is dropped one hundred times vertically onto uppermost surfaces of the barrier ribs from 5 mm above the uppermost surfaces, each of the barrier ribs having at least one layer; and the red phosphorous layer includes at least two kinds of oxides selected from the group consisting of oxides Y, Gd, B, and Eu, the green phosphorous layer includes at least one kind of oxide selected from the group consisting of oxides Zn, Si, Mn, Y, B, Tb, Ba, and Al, and the blue phosphorous layer comprises at least two kinds of oxides selected from the group consisting of oxides Ba, Mg, Al, Sr, Mn, and Eu, so that, in the phosphorous layers, color temperatures are maintained between 8,000 K and 13,000 K.

In the rear plate, barrier ribs are formed through etching after backing, and thus the completed barrier ribs are not deformed. Therefore, each electrode can be exactly located on a central portion between barrier ribs. When a PDP having front and rear plates attached to each other has been completed, optical characteristics of the PDP such as white brightness, color temperature, and contrast, and electric characteristics of the PDP such as voltage margin, power consumption, and electric efficiency, are improved, so that the reliability is improved.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a sectional view of a portion of a rear plate of a plasma display panel according to the present invention;

FIG. 2 is a graph showing an optical absorption ratio according to a ratio of volume of a filler with respect to a glass powder in a barrier rib of a rear plate according to an embodiment of the present invention; and

FIG. 3 is a graph showing an etching rate according to a ratio of volume of a filler with respect to a glass powder in a barrier rib of a rear plate according to an embodiment of the present invention.

### BEST MODE FOR CARRYING OUT THE INVENTION

Hereinafter, a rear plate of a plasma display panel according to a preferred embodiment of the present invention will be described in detail with reference to the accompanying drawings.

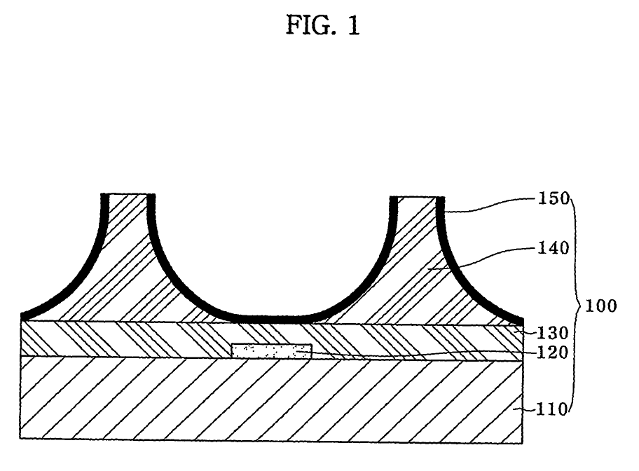

As shown in FIG. 1, a rear plate 100 of a plasma display panel (hereinafter, referred to as “PDP”) according to the present embodiment includes a glass substrate 110, electrodes 120 formed in a shape of a pattern and spaced at a predetermined interval from each other on an upper surface of the glass substrate 110, a dielectric layer 130 formed on upper surfaces of the electrode 120 and the upper surface of the glass substrate 110, barrier ribs 140 formed on an upper surface of the dielectric layer 130 and spaced a predetermined interval from each other, and phosphorous layers 150 formed on side surfaces and bottom surfaces of the barrier ribs 140.

A method of manufacturing the barrier rib 140 according to the present embodiment will be briefly described hereinafter. First, a process of printing paste for barrier ribs on the entire upper surface of the dielectric layer 130 and then drying the paste is repeated several times, thereby forming a barrier rib layer. Then, the barrier rib layer is baked, a latent image is formed on the baked barrier rib layer by photolithography, and then the barrier rib layer is etched, so that the barrier ribs 140 are completed.

Since etching is utilized in forming the barrier ribs 140, the barrier rib layer must have a proper etching rate for etching solution and the electrodes 120 and the dielectric layer 130 must have resistance to the etching solution. In order to meet the requirements described above, each of the functional layers of the rear plate 100 according to the present embodiment has a specific composition, which will be described hereinafter.

The electrode 120 is made from a mixture of a conductive metal powder and a first glass powder, which is a sintering agent for sintering the conductive metal powder at a low temperature. Preferably, the mixture includes a conductive metal powder of 51 to 99.5 wt % and a first glass powder of 0.5 to 49 wt %. When the mixture includes a conductive metal powder of less than 51 wt %, that is, when the mixture includes a first glass powder of more than 49 wt %, the resistance of the mixture is too high to lower the specific resistance of the electrode 120 under 5.0×10⁻⁶ Ωcm, which will be described later in more detail. In contrast, when the mixture includes a conductive metal powder of more than 99.5 wt %, that is, when the mixture includes a first glass powder of less than 0.5 wt %, the proportion of the first glass powder is too small to enable sufficient sintering.

The conductive metal powder has an average particle diameter of 0.1 to 7 μm. When the conductive metal powder has an average particle diameter of smaller than 0.1 μm, the conductive metal powder has such a large specific surface area as to make it difficult to disperse the conductive metal powder. In contrast, when the conductive metal powder has an average particle diameter of at least 7 μm, it is difficult to form an electrode having a thickness of at most 10 μm, which is a proper thickness for the electrode 120. The first glass powder has an average particle diameter of 0.5 to 10 μm. When the conductive metal powder has an average particle diameter of at most 0.5 μm, the conductive metal powder has such a large specific surface area as to make it difficult to disperse the conductive metal powder. In contrast, when the conductive metal powder has an average particle diameter of at least 10 μm, it is difficult for the first glass powder to function as a binder for binding the conductive metal powder.

The electrode 120 made from a mixture of the conductive metal powder and the first glass powder has a specific resistance of 1.0×10⁻⁶ to 5.0×10⁻⁶ Ωcm. When the electrode 120 has a specific resistance of less than 1.0×10⁻⁶ Ωcm, the quantity of the conductive metal powder contained in the electrode 120 is excessive, thereby increasing the manufacturing cost of the electrode 120. In contrast, when the electrode 120 has a specific resistance of more than 5.0×10⁻⁶ Ωcm, an address voltage, which is necessary in driving a PDP, becomes too high.

In order to possess the properties described above, the conductive metal powder includes at least one metal powder selected from the group consisting of powders of Au, Ag, Pt, Pd, Ni, and Cu, and the first glass powder includes a typical glass powder.

Hereinafter, the dielectric layer 130 formed on the electrodes 120 will be described. The dielectric layer 130 includes a first filler and at least one glass powder selected from among a second glass powder and a third glass powder.

It is preferred that each of the second and third glass powders has an average particle diameter of 0.5 to 10 μm. When each of the second and third glass powders has an average particle diameter of less than 0.5 μm, they have a reduced workability. In contrast, when each of the second and third glass powders has an average particle diameter of more than 10 μm, the dielectric layer 130 is not sufficiently compacted while being baked, so that the dielectric layer 130 may be porous.

It is also preferred that each of the second and third glass powders has a softening temperature of 390 to 550° C. When their softening temperature is smaller than 390° C., the dielectric layer 130 may flow in steps of firing the phosphorous layers and attaching the front plate and the rear plate of the PDP to each other after the barrier ribs 140 are formed, thereby deteriorating correctness in the measurements of the PDP. In contrast, when the softening temperature is larger than 550° C., the firing temperature of the dielectric layer 130 increases to change the measurements of the glass substrate 110, thereby causing it difficult to control the measurements of the glass substrate 110.

Also, each of the second and third glass powders preferably has a thermal expansive coefficient of 63×10⁻⁷ to 83×10⁻⁷/° C. When the thermal expansive coefficient is smaller than 63×10⁻⁷/° C., the glass substrate 110 may be convexly bent. In contrast, when the thermal expansive coefficient is larger than 83×10⁻⁷/° C., the glass substrate 110 may be concavely bent or the surface of the dielectric layer 130 may crack. However, even when each of the second and third glass powders preferably has a thermal expansive coefficient of 95×10⁻⁷/° C., the thermal expansive coefficient can be lowered to 83×10⁻⁷⁷/° C. by mixing a proper amount of the first filler with the second and third glass powder. Therefore, each of the second and third glass powders preferably may have a thermal expansive coefficient of 63×10⁻⁷ even up to 95×10⁻⁷/° C.

It is preferred that each of the second and third glass powders has a dielectric constant of 11 to 26. When the dielectric constant of the dielectric layer 130 is smaller than 11, it is difficult to transfer a signal of the electrode 120 to a discharge space defined by the barrier ribs 140. In contrast, when the dielectric constant of the dielectric layer 130 is larger than 26, the PDP has too slow a response speed when the PDP is driven. Meanwhile, when each of the second and third glass powders has a dielectric constant of at least 6, the dielectric constant of the dielectric layer 130 can be elevated up to 11 by means of the first filler. Therefore, it is also preferred that each of the second and third glass powders has a dielectric constant of 6 to 26.

Preferably, each of the second and third glass powders has an etching rate of 0.1 to 1.0 μm/min. When the etching rate is smaller than 0.1 μm/min, the firing temperature of the dielectric layer 130 may rise above 700° C., thereby deforming the glass substrate 110. In contrast, when the etching rate is larger than 1.0 μm/min, the powder has a reduced resistance to etching, so that even the dielectric layer 130 and the electrodes 120 may be etched when the barrier rib 140 is etched. When the electrode 120 is damaged by etching, the electric resistance of the electrode 120 increases.

It is preferred that a ratio of the volume of the first filler with respect to the volume of the glass powder in the dielectric layer is 0.05 to 0.30. When the volumetric ratio is less than 0.05, the dielectric layer 130 has a reflectance of at most 50%, thereby preventing the PDP from employing a dielectric layer having a reflectance of at least 50% which is necessary in order to enable the PDP to have an improved brightness. Further, in the case in which the volumetric ratio is more than 0.3, when the softening temperature of the glass powder is low, the dielectric constant is high and thus the response seed is slow. In contrast, when the softening temperature of the glass powder is high, the degree of firing of the dielectric layer 130 is deteriorated, so that it is difficult for the dielectric layer 130 to have a resistance to etching, and the dielectric layer 130 has a dielectric constant of at most 11.

In order to possess the properties as described above: the second glass powder comprises PbO of 30 to 80 wt %, ZnO of 0 to 20 wt %, SiO₂ of 0 to 20 wt %, B₂O₃ of 5 to 40 wt %, Al₂O₃ of 0 to 12 wt %, Na₂O+K₂O+Li₂O of 0 to 5 wt %, and BaO+CaO+MgO+SrO of 0 to 5 wt %; the third glass powder comprises Bi₂O₃ of 36 to 84 wt %, B₂O₃ of 5 to 28 wt %, PbO of 0 to 46 wt %, ZnO of 0 to 30 wt %, Al₂O₃ of 0 to 13 wt %, SiO₂ of 0 to 10 wt %, Na₂O+K₂O+Li₂O of 0 to 5 wt %, and BaO+CaO+MgO+SrO of 0 to 3 wt %; and the first filler has an average particle diameter of 10 μm and includes at least one oxide selected from the group consisting of TiO₂, ZrO₂, ZnO, Al₂O₃, BN, SiO₂, and MgO, which are white oxides.

When the second glass powder comprises PbO of less than 30 wt %, the softening temperature of the second glass powder becomes so high that the powder may lose fluidity and thus be insufficiently sintered. When the second glass powder comprises PbO of more than 80 wt %, the powder has such a high thermal expansive coefficient that the dielectric layer 130 may have a cracked surface or be bent. Further, when the second glass powder comprises ZnO of more than 20 wt % or Na₂O+K₂O+Li₂ of more than 5 wt %, the second glass powder may be crystallized. Further, when the second glass powder comprises either SiO₂ of more than 20 wt %, or Al₂O₃ of more than 12 wt %, or BaO+CaO+MgO+SrO of more than 5 wt %, the softening temperature of the second glass powder becomes so high that the powder may lose fluidity and thus be insufficiently sintered. Also, when the second glass powder comprises B₂O₃ of less than 5 wt %, the softening temperature of the second glass powder becomes so high that the powder may lose fluidity and thus be insufficiently sintered. In contrast, when the second glass powder comprises B₂O₃ of more than 40 wt %, phase separation may be caused in the second glass powder.

When the third glass powder comprises Bi₂O₃ of less than 36 wt %, the softening temperature of the third glass powder becomes so high that the powder may lose fluidity and thus be insufficiently sintered. When the third glass powder comprises Bi₂O₃ of more than 84 wt %, the softening temperature becomes too low. When the third glass powder comprises B₂O₃ of less than 5 wt %, it is difficult to vitrify the dielectric layer 130. When the third glass powder comprises B₂O₃ of more than 28 wt %, phase separation may be caused in the third glass powder. Further, when the third glass powder comprises PbO of more than 46 wt %, the powder has such a high thermal expansive coefficient that the dielectric layer 130 may have a cracked surface or be bent. Further, when the third glass powder comprises ZnO of more than 30 wt % or Na₂O+K₂O+Li₂O of more than 5 wt %, the third glass powder may be crystallized. Further, when the third glass powder comprises either SiO₂ of more than 10 wt %, or Al₂O₃ of more than 13 wt %, or BaO+CaO+MgO+SrO of more than 3 wt %, the softening temperature of the third glass powder becomes so high that the powder may lose fluidity and thus be insufficiently sintered.

The dielectric layer 130 having the ingredients as described above has a dielectric constant of 11 to 26, a reflectance of 50 to 80%, and an etching rate of 0.1 to 1.0 μm/min, when the dielectric layer 130 has been baked for 10 to 60 minutes at 450 to 600° C. Further, the dielectric layer 130 has a porosity of 5%.

The reason because the dielectric layer 130 has a dielectric constant of 11 to 26 and an etching rate of 0.1 to 1.0 μm/min is the same as that for the second and third glass powders. Further, when the dielectric layer 130 has a reflectance of less than 50%, the PDP has a deteriorated brightness. The dielectric layer 130 has a reflectance of at least 85% when the dielectric layer 130 contains a large quantity of the first filler or has been insufficiently baked. However, when the dielectric layer 130 has a reflectance of more than 85%, it is difficult to obtain a desired etching rate. Therefore, the dielectric layer 130 may have a reflectance of 50 to 80%.

Further, when the dielectric layer 130 has a porosity of more than 5%, the dielectric layer 130 may contain a relatively large bubble. Then, the dielectric layer 130 has a low withstand voltage, dielectric breakdown may be caused while the PDP is being driven.

Next, a result of an experiment in which properties of the dielectric layer 130 having the composition as described above have been measured will be described.

First, softening temperatures, etching rates, and dielectric constants of the second glass powder, which have been measured from various combinations of ingredients of the second glass powder, will be described hereinafter.

TABLE 1
Properties of the second glass powder measured from
various combinations of ingredients of the second glass powder:

| | | | | | | | | Properties | | |
|---|---|---|---|---|---|---|---|---|---|---|
| 2nd | Proportions of ingredients (wt %) | | | | | | | Softening | Etching | |
| glass | | | | | | BaO + CaO + | Na₂O + K₂O + | temperature | rates | Dielectric |
| powder | PbO | B₂O₃ | ZnO | SiO₂ | Al₂O₃ | MgO + SrO | Li₂O | (° C.) | (μm/min) | constants |
| Ex. 1 | 32 | 39 | 6 | 16 | 6 | 0 | 1 | 527 | 0.87 | 6.2 |
| Ex. 2 | 53 | 8 | 19 | 3 | 10 | 2 | 5 | 485 | 0.63 | 8.5 |
| Ex. 3 | 61 | 30 | 6 | 1 | 2 | 0 | 0 | 467 | 0.95 | 15.4 |
| Ex. 4 | 44 | 26 | 10 | 12 | 5 | 1 | 2 | 511 | 0.23 | 12.7 |
| Ex. 5 | 75 | 10 | 3 | 4 | 4 | 4 | 0 | 432 | 0.98 | 20.3 |
| Ex. 6 | 53 | 6 | 10 | 13 | 12 | 2 | 0 | 535 | 0.12 | 13.2 |

As apparent from Table 1, examples 1 to 6 of the second glass powder have softening temperatures within a range between 390 and 550° C., etching rates within a range between 0.1 and 1.0 μm/min, and dielectric constants within a range between 6 and 26.

Hereinafter, a method of measuring an etching rate will be described. First, the second glass powder according to one of examples 1 to 6 is applied on an entire upper surface of a substrate such as a glass substrate, which is then baked. Then, acid-resistant tapes are attached to an upper surface of the baked second glass powder with intervals of 5 mm spaced from each other. Thereafter, the substrate is etched for ten minutes by acid-based etching solution, is washed for five minutes by ultrasonic waves and for one minute by flowing water, and is then dried. Thereafter, a depth by which the second glass powder has been etched is measured. Then, the etching rate is obtained by dividing the measured depth by etching time.

Next, softening temperatures, etching rates, and dielectric constants of the third glass powder, which have been measured from various combinations of ingredients of the second glass powder, will be described.

TABLE 2
Properties of the second glass powder measured from
various combinations of ingredients of the third glass powder:

| | | | | | | | | | Properties | | |
|---|---|---|---|---|---|---|---|---|---|---|---|
| 3rd | Proportions of ingredients (wt %) | | | | | | | | Softening | Etching | |
| Glass | | | | | | | Na₂O + K₂O + | BaO + CaO + | temperatures | Rates | Dielectric |
| Powder | Bi₂O₃ | B₂O₃ | PbO | ZnO | Al₂O₃ | SiO₂ | Li₂O | MgO + SrO | (° C.) | (μm/min) | Constants |
| Ex. 7 | 43 | 11 | 42 | 0 | 1 | 1 | 2 | 0 | 394 | 0.43 | 12.7 |
| Ex. 8 | 83 | 6 | 0 | 0 | 3 | 4 | 4 | 0 | 414 | 0.31 | 18.2 |
| Ex. 9 | 70 | 17 | 0 | 8 | 2 | 0 | 1 | 2 | 464 | 0.40 | 10.3 |
| Ex. 10 | 63 | 16 | 2 | 17 | 0 | 2 | 0 | 0 | 473 | 0.22 | 15.1 |
| Ex. 11 | 61 | 10 | 0 | 28 | 0 | 0 | 1 | 0 | 512 | 0.49 | 11.3 |
| Ex. 12 | 50 | 28 | 0 | 8 | 14 | 0 | 0 | 0 | 562 | 0.23 | 12.5 |

As apparent from Table 2, examples 7 to 12 of the third glass powder have softening temperatures within a range between 390 and 550° C., etching rates within a range between 0.1 and 1.0 μm/min, and dielectric constants within a range between 6 and 26.

That is, as noted from Tables 1 and 2, the second and third glass powder have properties within desired ranges when they have ingredients combined according to proportions within the ranges described above.

Next, measured properties of the dielectric layers 130, which are produced by mixing the second glass powder according to example 3 and the third glass powder according to example 11 or 12 with the first filler and then firing them, will be described. In this case, TiO₂ is used as the first filler.

TABLE 3
Measured properties of a dielectric layer:

| | Glass powder | | | | Voluminal | | | | | |
|---|---|---|---|---|---|---|---|---|---|---|
| Class. | Type | | | | Ratio of | Dielectric layer | | | | |
| Type | of | Softening | Etch | | Filler/ | Firing | | | | Etch |
| of | Glass | Temperature | rate | Dielectric | glass | temperature | Dielectric | | | Rate |
| Dielectric | powder | (° C.) | (μm/min) | constant | powder | (° C.) | constant | Reflectivity | Porosity | (μm/min) |
| Ex. 1 | Ex. 3 | 467 | 0.95 | 15.4 | 0.20 | 550 | 20.4 | 70 | 2 | 0.53 |
| Ex. 2 | Ex. 3 | 467 | 0.95 | 15.4 | 0.35 | 550 | 29 | 76 | 3 | 0.46 |
| Ex. 3 | Ex. 3 | 467 | 0.95 | 15.4 | 0.20 | 530 | 18.6 | 73 | 4 | 0.74 |
| Ex. 4 | Ex. 11 | 512 | 0.49 | 11.3 | 0.20 | 550 | 15.2 | 70 | 4 | 0.21 |
| Ex. 5 | Ex. 11 | 512 | 0.49 | 11.3 | 0.35 | 530 | 5.7 | 79 | 25 | 4.91 |
| Ex. 6 | Ex. 11 | 562 | 0.23 | 12.5 | 0.20 | 550 | 4.5 | 82 | 14 | 7.92 |

As shown in Table 3, the dielectric layer 130 according to example 1 is made by mixing the first filler with the second glass powder according to example 3 having a softening temperature within the range of 390 to 550° C. by a volumetric ratio of at most 0.3, which enables all properties of the dielectric layer 130 according to example 1 to be within the desired conditions described above. However, the dielectric layer 130 according to example 2 is made by the same mixture with a volumetric ratio of larger than 0.3, which causes the dielectric constant to be larger than 26, thereby making it difficult to use the dielectric layer 130 according example 2. The dielectric layer 130 according to example 3 is nearly the same as the dielectric layer 130 according to example 1, excepting that the firing temperature for firing the dielectric layer 130. As understood from the dielectric layers 130 according to example 1 and 3, properties of the dielectric layer 130 can be adjusted by adjusting the firing temperature of the dielectric layer 130.

Further, the dielectric layer 130 according to example 4 is made by mixing the first filler with the third glass powder according to example 11 having a softening temperature within the range of 390 to 550° C. by a volumetric ratio of at most 0.3, and thus the dielectric layer 130 according to example 4 is usable. In contrast, the dielectric layer 130 according to example 5 is made by the same mixture with a volumetric ratio of larger than 0.3, which causes the dielectric constant of the dielectric layer 130 to be smaller than 6 and the etching rate to be larger than 1 μm/min, thereby making it difficult to use the dielectric layer 130 according to example 5.

Moreover, the dielectric layer 130 according to example 6 is made by mixing the first filler with the third glass powder according to example 12 having a softening temperature outside the range of 390 to 550° C. by a volumetric ratio of at most 0.3, which causes the dielectric constant of the dielectric layer 130 to be smaller than 6 and the etching rate to be larger than 1 μm/min, thereby making it difficult to use the dielectric layer 130 according to example 6.

Next, the barrier rib 140 formed on the upper surface of the dielectric layer 130 will be described.

The barrier rib 140 is made by mixing at least one glass powder selected from the group consisting of the fourth, fifth, and sixth glass powders with at least one filler selected from the group consisting of the dark second filler and the white third filler. The barrier rib 140 includes one or more layers.

Each of the fourth, fifth, and sixth glass powders has an average particle diameter of 0.5 to 10 μm. When the glass powder has an average particle diameter of smaller than 0.5 μm, it is difficult to make paste for the barrier rib. In contrast, when the conductive metal powder has an average particle diameter of larger than 10 μm, it is difficult to enable the barrier ribs to be sufficiently compact through firing after forming the barrier ribs.

Each of the fourth, fifth, and sixth glass powders has a softening temperature of 390 to 630° C. In the case where the softening temperature is smaller than 390° C., when the phosphorous layers 150 are baked after the barrier ribs 140 are formed or after the front and rear plates are attached to each other, the barrier ribs 140 may be deformed so that the barrier ribs 140 may have much irregular heights and their upper portions may have much irregular widths. In contrast, in a case where the softening temperature is larger than 630° C., the firing temperature of the barrier rib 140 increases to change the measurements of the glass substrate 110, thereby causing it difficult to control the measurements of the glass substrate 110.

Each of the fourth, fifth, and sixth glass powders preferably has a thermal expansive coefficient of 63×10⁻⁷ to 83×10⁻⁷/° C. When the thermal expansive coefficient is smaller than 63×10⁻⁷/° C., the glass substrate 110 may be convexly bent. In contrast, when the thermal expansive coefficient is larger than 83×10⁻⁷/° C., the glass substrate 110 may be concavely bent or the surface of the glass substrate 110 may crack. However, since the thermal expansive coefficient can be changed by adjusting the amount of the filler in the barrier rib 140, each of the fourth, fifth, and sixth glass powders preferably may have a thermal expansive coefficient of 63×10⁻⁷ even up to 110×10⁻⁷/° C.

It is preferred that each of the fourth, fifth, and sixth glass powders has a dielectric constant of 5 to 20. In the case where the dielectric constant is smaller than 5, a drive voltage characteristic is deteriorated when a manufactured PDP is driven. In contrast, in the case where the dielectric constant is larger than 20, crosstalk and erroneous discharge may happen when the manufactured PDP is driven.

Preferably, each of the fourth, fifth, and sixth glass powders has an etching rate of 2.0 to 50.0 μm/min. When the etching rate is smaller than 2.0 μm/min, it takes too much time in forming the barrier ribs 140. Meanwhile, it is difficult to realize the etching rate of 50.0 μm/min by the composition of the fourth, fifth, and sixth glass powder.

It is preferred that a ratio of the volume of the first filler with respect to the volume of the glass powder for the barrier ribs is 0.05 to 0.67, which will be described later.

In order to possess the properties as described above: the fourth glass powder comprises ZnO of 0 to 48 wt %, SiO₂ of 0 to 21 wt %, B₂O₃ of 25 to 56 wt %, Al₂O₃ of 0 to 12 wt %, Na₂O+K₂O+Li₂O of 0 to 38 wt %, and BaO+CaO+MgO+SrO of 0 to 15 wt %; the fifth glass powder comprises PbO of 25 to 65 wt %, ZnO of 0 to 35 wt %, SiO₂ of 0 to 26 wt %, B₂O₃ of 5 to 30 wt %, Al₂O₃+SnO₂ of 0 to 13 wt %, Na₂O+K₂O+Li₂O of 0 to 19 wt %, BaO of 0 to 26 wt %, and CaO+MgO+SrO of 0 to 13 wt %; the sixth glass powder comprises PbO of 35 to 55 wt %, B₂O₃ of 18 to 25 wt %, ZnO of 0 to 35 wt %, BaO of 0 to 16 wt %, SiO₂+Al₂O₃+SnO₂ of 0 to 9 wt %, CoO+CuO+MnO₂+Fe₂O₃ of 0 to 15 wt %, Na₂O+K₂O+Li₂O of 0 to 19 wt %, and CaO+MgO+SrO of 0 to 13 wt %; the second filler has an average particle diameter of 0.1 to 10 μm and includes at least two oxides selected from the group consisting of NiO, Fe₂O₃, CrO, MnO₂, CuO, Al₂O₃, and SiO₂, which have dark colors; and the third filler has an average particle diameter of 0.1 to 10 μm and includes at least one oxide selected from the group consisting of TiO₂, ZrO₂, ZnO, Al₂O₃, BN, SiO₂, and MgO, which have white colors.

When the fourth glass powder comprises ZnO of more than 48 wt %, the dielectric constant of the fourth glass powder may become too high. Further, when the fourth glass powder comprises either SiO₂ of more than 21 wt %, or Al₂O₃ of more than 12 wt %, or BaO+CaO+MgO+SrO of more than 15 wt %, the softening temperature of the fourth glass powder becomes so high that the fourth glass powder may be insufficiently sintered. Also, when the fourth glass powder comprises B₂O₃ of less than 25 wt %, the softening temperature of the fourth glass powder becomes so high that the powder may be insufficiently sintered. In contrast, when the fourth glass powder comprises B₂O₃ of more than 56 wt %, phase separation is apt to occur in the fourth glass powder. Further, when the fourth glass powder comprises Na₂O+K₂O+Li₂O of 0 to 38 wt %, the fourth glass powder may be crystallized.

When the fifth glass powder comprises Pbo of less than 25 wt %, the fifth glass powder has such a high softening temperature that the fifth glass powder may be insufficiently sintered. In contrast, when the fifth glass powder comprises PbO of more than 65 wt %, the fifth glass powder has such a high thermal expansive coefficient that a surface of the barrier rib 140 may crack or may be bent. Further, when the fifth glass powder comprises ZnO of more than 35 wt %, the fifth glass powder has a slow viscosity change at a high temperature. When the fifth glass powder comprises either SiO₂ of more than 26 wt %, or B₂O₃ of more than 30 wt %, or Al₂O₃+SnO₂ of more than 13 wt %, the fifth glass powder has such a high softening temperature that the fifth glass powder may be insufficiently sintered. Further, when the fifth glass powder comprises Na₂O+K₂O+Li₂O of more than 19 wt %, the fifth glass powder is apt to be crystallized. When the fifth glass powder comprises BaO of more than 26 wt %, the fifth glass powder has such a high thermal expansive coefficient, which may cause the barrier rib 140 to crack. When the fifth glass powder comprises CaO+MgO+SrO of 0 to 13 wt %, the fifth glass powder has such a high softening temperature which may cause the fifth glass powder to be insufficiently sintered.

When the sixth glass powder comprises PbO of less than 35 wt %, the sixth glass powder has such a high softening temperature that the sixth glass powder may be insufficiently sintered. In contrast, when the sixth glass powder comprises PbO of more than 55 wt %, the sixth glass powder has such a high thermal expansive coefficient that a surface of the barrier rib 140 may crack or may be bent. Further, when the sixth glass powder comprises B₂O₃ of less than 18 wt %, it is difficult to vitrify the barrier ribs 140. When the sixth glass powder comprises either B₂O₃ of mor than 25 wt %, or BaO of more than 16 wt %, or SiO₂+Al₂O₃+SnO₂ of more than 9 wt %, or CaO+MgO+SrO of more than 13 wt %, the sixth glass powder such a high softening temperature which deteriorates fluidity of the sixth glass powder. When the sixth glass powder comprises either ZnO of more than 35 wt %, or Na₂O+K₂O+Li₂O of more than 19 wt %, or CoO+CuO+MnO₂+Fe₂O₃ of more than 15 wt %, the sixth glass powder may be crystallized.

The barrier rib 140 formed of the ingredients described above has a dielectric constant of 5 to 16 and an etching rate of 2 to 50 μm/min and can be bent at most 0.5 mm, when the barrier rib 140 has been baked for 10 to 60 minutes at 450 to 600° C. Further, when the barrier ribs 140 have a height change of at most 1%, the barrier rib 140 has a proportion of destruction of at most 50%, which will be addressed later.

Next, a result of an experiment in which properties of the barrier rib 140 having the composition as described above have been measured will be described.

Tables 4, 5, 6 represent thermal expansive coefficients, bending, dielectric constants, and etching rates of the fourth, fifth, and sixth glass powder, which have been measured from various combinations of ingredients of the fourth, fifth, and sixth glass powder.

TABLE 4
Properties of the fourth glass powder measured from
various combinations of ingredients of the fourth glass powder:

| | | | | | | | Properties | | | |
|---|---|---|---|---|---|---|---|---|---|---|
| | Proportions of ingredients (wt %) | | | | | | Thermal | | | |
| 4^{th} | | | | | Li₂O + | | expansive | | | |
| glass | | | | | Na₂O + | MgO + CaO + | coeffic. | | Dieletric | Etch |
| powder | ZnO | SiO₂ | B₂O₃ | Al₂O₃ | K₂O | BaO + SrO | (×10⁻⁷/° C.) | Bending | Const. | Rate |
| Ex. 13 | 30 | 9 | 25 | 13 | 8 | 15 | 60 | + | 13 | 10.2 |
| Ex. 14 | 0 | 21 | 27 | 12 | 40 | 0 | 112 | − | 15 | 2.0 |
| Ex. 15 | 30 | 2 | 56 | 6 | 1 | 5 | 74 | | 8 | 4.2 |
| Ex. 16 | 22 | 21 | 30 | 5 | 21 | 1 | 93 | | 17 | 30.9 |
| Ex. 17 | 40 | 1 | 46 | 1 | 12 | 0 | 68 | | 6 | 16.5 |
| Ex. 18 | 19 | 6 | 37 | 0 | 38 | 0 | 79 | | 20 | 42.0 |
| Ex. 19 | 48 | 5 | 25 | 1 | 6 | 15 | 73 | | 12 | 21.3 |

TABLE 5
Properties of the fifth glass powder measured from
various combinations of ingredients of the fifth glass powder:

| | | | | | | | | | Properties | | | |
|---|---|---|---|---|---|---|---|---|---|---|---|---|
| | Proportions of ingredients (wt %) | | | | | | | | Thermal | | | |
| 5^{th} | | | | | | Li₂O + | | | Expansive | | | Etch |
| glass | | | | | Al₂O₃ + | Na₂O + | | CaO + MgO + | coeffic. | | Dielectric | Rate |
| powder | PbO | ZnO | SiO₂ | B₂O₃ | SnO₂ | K₂O | BaO | SrO | (×10⁻⁷/° C.) | Bending | ratio | (μm/min) |
| Ex. 20 | 25 | 27 | 26 | 1 | 13 | 5 | 0 | 3 | 72 | | 8 | 3.6 |
| Ex. 21 | 40 | 22 | 6 | 10 | 2 | 20 | 0 | 1 | 129 | − | 19 | 48.2 |
| Ex. 22 | 52 | 14 | 27 | 1 | 4 | 1 | 0 | 1 | 61 | | 11 | 8.2 |
| Ex. 23 | 26 | 30 | 4 | 7 | 8 | 18 | 0 | 5 | 103 | + | 15 | 16.8 |
| Ex. 24 | 41 | 35 | 15 | 3 | 2 | 2 | 0 | 2 | 78 | | 10 | 18.4 |
| Ex. 25 | 65 | 6 | 12 | 8 | 1 | 6 | 0 | 2 | 95 | | 11 | 28.2 |
| Ex. 26 | 27 | 12 | 1 | 29 | 1 | 4 | 26 | 0 | 65 | | 14 | 21.7 |
| Ex. 27 | 29 | 31 | 7 | 17 | 1 | 7 | 0 | 8 | 81 | | 13 | 35.1 |
| Ex. 28 | 41 | 18 | 8 | 6 | 7 | 7 | 0 | 13 | 100 | | 12 | 38.9 |

TABLE 6
Properties of the sixth glass powder measured from
various combinations of ingredients of the sixth glass powder:

| | | | | | | | | | Properties | | | |
|---|---|---|---|---|---|---|---|---|---|---|---|---|
| | Proportions of ingredients (wt %) | | | | | | | | Thermal | | | Etch |
| 6^{th} | | | | | SiO₂ + | | | MgO + | Expansive | | | Rate |
| glass | | | | | Al₂O₃ + | CoO + CuO + | Na₂O + | CaO + | coeffic. | | Dielectric | (μm/ |
| powder | PbO | B₂O₃ | ZnO | BaO | SnO₂ | MnO₂ + Fe₂O₃ | CaO + SrO | SrO | (×10⁻⁷/° C.) | Bending | ratio | min) |
| Ex. 29 | 31 | 22 | 19 | 2 | 3 | 18 | 0 | 5 | 62 | + | 13 | 19.2 |
| Ex. 30 | 55 | 20 | 0 | 16 | 1 | 5 | 1 | 2 | 96 | | 16 | 42.6 |
| Ex. 31 | 36 | 18 | 10 | 8 | 0 | 7 | 19 | 2 | 102 | | 20 | 33.6 |
| Ex. 32 | 38 | 22 | 3 | 14 | 2 | 7 | 7 | 7 | 76 | | 12 | 15.4 |
| Ex. 33 | 35 | 20 | 15 | 8 | 4 | 15 | 0 | 3 | 69 | | 11 | 28.5 |
| Ex. 34 | 46 | 24 | 1 | 9 | 1 | 2 | 2 | 15 | 112 | − | 15 | 8.4 |
| Ex. 35 | 42 | 19 | 8 | 15 | 9 | 2 | 0 | 5 | 64 | | 13 | 5.4 |
| Ex. 36 | 36 | 25 | 33 | 3 | 0 | 2 | 0 | 1 | 102 | | 18 | 21.2 |
| Ex. 37 | 47 | 20 | 6 | 13 | 0 | 1 | 0 | 13 | 84 | | 8 | 17.1 |

As apparent from Table 4, 5, and 6, the fourth, fifth, and sixth glass powder have thermal expansive coefficients, dielectric constants, and etching rates, which have values always within ranges between 63×10⁻⁷ and 110×10⁻⁷/° C., between 5 and 20, and between 2.0 and 50.0 μm/min, respectively, on condition that the fourth, fifth, and sixth glass powder have ingredients mixed by the proportions described above.

Further, in order to measure the bending, paste for barrier ribs, which contains at least one glass powder selected from the group consisting of the fourth, fifth, and sixth glass powder, is applied on the entire surface of a soda lime substrate with a size of 862 mm×688 mm, and is then baked. When the baked paste is convexly bent at least 500 μm, the bending is marked as “+”. In contrast, when the baked paste is concavely bent at least 500 μm, the bending is marked as “−”.

Next, barrier ribs made by mixing one glass powder selected from the group consisting of the fourth, fifth, and sixth glass powder with one filler selected from the group consisting of the second and third fillers will be described.

The second filler has a function of increasing the image contrast of a PDP, but may decrease the brightness thereof. Therefore, the second filler and the third filler may be selectively used according to necessity.

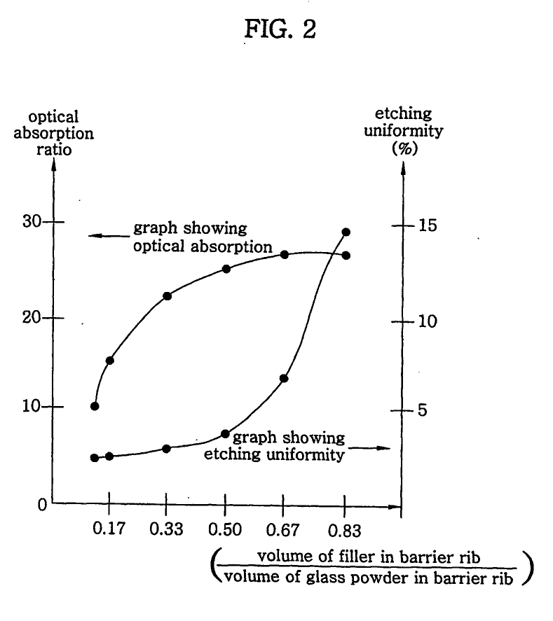

When a ratio of volume of the second filler with respect to volume of glass powder for the barrier rib is at most 0.05, the mixture has a good etching uniformity but a bad optical absorption ratio which deteriorates the contrast in a driven PDP. In contrast, when the ratio is at least 0.67, the mixture has a good optical absorption ratio but a bad etching uniformity. Hereinafter, the optical absorption ratio and the etching uniformity will be described with reference to FIG. 2.

First, when r implies a width of an uppermost portion of a barrier rib, r′ implies a mean value of r, and R implies a range of r, the etching uniformity is defined as a percentage (%) calculated by a formula [(R/r′)×100], that is, an etching uniformity (%)=[(R/r′)×100]. Further, the optical absorption ratio is defined by an equation, an optical absorption ratio={100%−(optical reflectance)−(optical transmissivity)}. Further, when f implies a ratio of volume of the second filler with respect to volume of glass powder for the barrier rib, the optical absorption ratio is defined by another equation, an optical absorption ratio=(f/0.1). Herein, when the etching uniformity is smaller than or equal to 7%, the barrier rib is usable and has a good quality.

As shown in FIG. 2, when the barrier ribs have been made by mixing the second filler with the fifth glass powder according to example 25 by a volumetric ratio of 0.05 to 0.67, the barrier ribs have an etching uniformity of at most 7 and an optical absorption ratio of at least 1. Therefore, the barrier ribs according to the present embodiment have a good quality.

Further, the etching uniformity abruptly increases when the volumetric ratio is larger than 0.67, while it decreases when the volumetric ratio is smaller than 0.05. However, when the etching uniformity is too low, it is difficult to intercept colored light radiated from phosphors applied on an adjacent barrier rib, so that color mixing may occur.

The third filler can be classified into two kinds of oxides, which have weak and strong chemical durability with respect to acid-based etching solution, respectively. The first kind of oxide having a weak chemical durability with respect to acid-based etching solution reacts with glass powder while it is baked, thereby deteriorating the chemical durability of the reacted glass powder. In contrast, the second kind of oxide having a strong chemical durability with respect to acid-based etching solution reacts with glass powder while it is baked, thereby increasing the chemical durability of the reacted glass powder. Further, when the ratio of volume of the third filler with respect to volume of the glass powder of the barrier ribs is smaller than 0.05, such a small proportion of the third filler decreases the white degree, to make it difficult to intercept colored light radiated from phosphors applied on an adjacent barrier rib, thereby allowing color mixing to occur. Further, when the volumetric ratio is larger than 0.67, quantity of the third filler, which does not react with the oxide, increases, so that firing strength deteriorates.

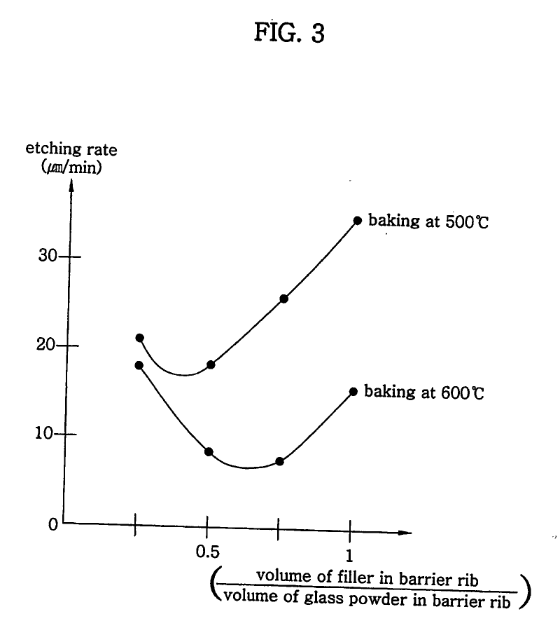

An etching rate of barrier ribs, which are made from the fourth glass powder and the third filler employing TiO₂, will be described hereinafter with reference to FIG. 3. The etching rate is defined as a total value per minute, which includes quantity of an etched portion by the etching solution, quantity of an unbaked portion separated by the ultrasonic washing, and quantity of a portion of the barrier ribs which has a reduced firing strength due to the etching.

As shown in FIG. 3, when barrier ribs having a volumetric ratio of 0.05 to 0.67 is baked at a temperature between 450 and 600° C., the barrier ribs can have an etching rate always between 2.0 and 50 μm/min, which is a desired range.

Next, measured dielectric constants, etching rates, bending, height changes, destruction ratios of barrier ribs according to types of fillers of the barrier ribs, number of the barrier ribs, and ratios of volume of the third filler with respect to volume of the glass powder of the barrier ribs will be described with reference to Table 7.

TABLE 7
Properties of barrier ribs according to types of
fillers, number of the barrier ribs, and volumetric ratios of glass powder:

| | | | Volumetric | Properties | | | | |
|---|---|---|---|---|---|---|---|---|
| | Type | | ratio of | | Etch | | | |
| | of | Type | Filler/ | | rate | | Height | |
| | Partition | of | glass | Dielectric | (μm/ | Bending | difference | Destruction |
| Class | wall | filler | powder | constant | min) | (mm) | (%) | ratio(%) |
| Ex. 1 | Single | Al₂O₃ | 0.52 | 10.1 | 28 | 0.21 | <0.5 | 9 |
| | layer | | | | | | | |
| Ex. 2 | Single | Spinel | 0.23 | 12.3 | 17 | 0.24 | <0.5 | 21 |
| | layer | | | | | | | |
| Ex. 3 | Upper | TiO₂ + Al₂O₃ | 0.47 | 10.4 | 25 | 0.02 | <0.5 | 10 |
| | layer | | | | | | | |
| | Lower | TiO₂ + Al₂O₃ | 0.32 | 10.2 | | | | |
| | layer | | | | | | | |
| Ex. 4 | Upper | Spinel + Al₂O₃ | 0.35 | 15.2 | 22 | 0.13 | <0.5 | 15 |
| | layer | | | | | | | |
| | Lower | TiO₂ + Al₂O₃ | 0.35 | 11.3 | | | | |
| | layer | | | | | | | |

The spinel in Table 7 implies spinel-based compound oxide.

As shown in Table 7, the dielectric constants and etching rates of the barrier ribs belong to ranges of 5 to 20 and 2.0 to 50.0 μm/min, respectively, which implies that they have desired values.

When the bending of the glass substrate 110 including the barrier ribs 140 is large, it is difficult to attach the front plate and the rear plate to each other, and the PDP may be distorted even after the front plate and the rear plate are attached to each other. Herein, it is preferred that the bending of the glass substrate 110 including the barrier ribs 140 is at most 1 mm, the bending of the glass substrate 110 including the barrier ribs 140 according to the present embodiment is only 0.3 mm. Therefore, it can be said that the barrier ribs 140 according to the present embodiment are excellent.

The height change is defined as [{(h1−h2)/h2}×100], wherein h1 implies height of the barrier ribs formed through etching by means of acid-based etching solution and h2 implies height of the barrier ribs measured after the barrier ribs formed through the etching are baked at 510° C. for one hour. When the height change is more than 1%, it is difficult to manufacture a PDP because the barrier ribs undergo size change while the phosphorous layer is baked and the front plate and the rear plate are attached to each other after the barrier ribs are formed. Herein, all of the barrier ribs formed according to the present embodiment show a height change of at most 0.5%.

In order to examine the destruction ratio of the barrier ribs, the barrier ribs are first formed through etching by means of acid-based etching solution and are then put on a predetermined structure. Then, an iron rod, which weighs 500 g and has an end portion shaped like a sphere having a radius of 3 mm, is dropped one hundred times vertically onto the uppermost surfaces of the barrier ribs from 5 mm above the uppermost surfaces. Then, the barrier ribs and the structure are inspected with an inclination of 10 to 30° by naked eye. Herein, the destruction ratio is defined as the number of barrier ribs which have been either deformed or destroyed. When the destruction ratio is larger than 50%, the barrier ribs may be destructed by vibration and impact while a completed PDP having the barrier ribs is moved or used.

Next, the phosphorous layers 150 formed on the upper surfaces of the barrier ribs 140 will be described. The phosphorous layers 150 include red, green, and blue phosphorous layers.

The red phosphorous layer comprises at least two kinds of oxides selected from the group consisting of oxides Y, Gd, B, and Eu, and radiates red visible rays according to an electric signal. The green phosphorous layer comprises at least one kind of oxide selected from the group consisting of oxides Zn, Si, Mn, Y, B, Tb, Ba, and Al, and radiates green visible rays according to an electric signal. Further, the blue phosphorous layer comprises at least two kinds of oxides selected from the group consisting of oxides Ba, Mg, Al, Sr, Mn, and Eu, and radiates blue visible rays according to an electric signal. Therefore, in the phosphorous layers 150, color temperatures are maintained between 8,000 K and 13,000 K.

The proportions of ingredients of the red, green, and blue phosphorous layers have degrees of freedom according to color coordinates determined by the efficiency of each phosphorous layer and the area on which each phosphorous layer is applied. Therefore, there is no restriction on the proportions of ingredients of the phosphorous layers.

Next, electrical, optical, and mechanical characteristics of a rear plate of a PDP according to the present embodiment will be compared with those of the conventional rear plate.

TABLE 8
Dimensions of each functional layer of a rear plate of
the present invention and the conventional rear plate:

| | | Conventional | Rear plate according to the invention | | | | |
|---|---|---|---|---|---|---|---|
| Class | | rear plate | 1 | 2 | 3 | 4 | 5 |
| Dielectric | Thickness | 20 | 20 | 21 | 20 | 20 | 20 |
| layer | (μm) | | | | | | |
| Barrier | Height (μm) | 132 | 130 | 132 | 130 | 131 | 130 |
| rib | Upper width | 75 | 75 | 74 | 75 | 74 | 75 |
| | (μm) | | | | | | |
| | Pitch (μm) | 420 | 420 | 420 | 420 | 420 | 420 |
| | Manufacturing | Sand | Etching | Etching | Etching | Etching | Etching |
| | method | blasting | | | | | |

In the conventional rear plate shown in Table 8, dedicated materials for sandblasting have been used for the electrodes, dielectric layer, and barrier ribs. In examples 1 to 5 according to the present invention, the electrodes 120 have been made from material, which includes Ag powder of 97 wt % and glass powder of 3 wt %, the dielectric layer 130 has been made from dielectric corresponding to example 4 in Table 3, and the barrier ribs 140 have been made from the material corresponding to example 3 in Table 7.

Herein, a PDP employing a rear plate according to the present invention has the same drive circuit as that of a PDP employing the conventional rear plate. Further, a process of attaching a rear plate according to the present invention to a front plate is the same as the conventional process thereof. “Pitch” in Table 8 implies a distance between centers of adjacent two barrier ribs.

Properties of PDPs which employ the conventional rear plate and a rear plate according to the present invention, respectively, will be described with reference to Table 9.

TABLE 9
Properties of PDPs employing the conventional rear
plate and a rear plate according to the present invention, respectively:

| Class | | Conventional | | | | | |
|---|---|---|---|---|---|---|---|
| Properties | | Rear plate | Ex. 1 | Ex. 2 | Ex. 3 | Ex. 4 | Ex. 5 |
| Optical | White Peak | 100% | 132% | 135% | 133% | 134% | 132% |
| Property | brightness | | | | | | |
| | Color | 8500 | 8802 | 8758 | 8773 | 8782 | 8793 |
| | temper.(K) | | | | | | |
| | Contrast | 100% | 128% | 134% | 131% | 130% | 129% |
| Electric | Voltage | 100% | 145% | 142% | 143% | 143% | 144% |
| property | Margin | | | | | | |
| | Power | 100% | 89% | 88% | 88% | 89% | 90% |
| | consumption | | | | | | |
| | Module | 100% | 125% | 127% | 127% | 126% | 125% |
| | efficiency | | | | | | |
| Reliability | High & low | No | No | No | No | No | No |
| | temperature | | | | | | |
| | mis-discharge | | | | | | |
| | Vibration & | No | No | No | No | No | No |
| | drop test | progressive | progressive | progressive | progressive | progressive | progressive |
| | | defect | defect | defect | defect | defect | defect |
| Other | Noise(dB) | 100% | 75% | 76% | 76% | 77% | 75% |
| properties | Panel | 0.7 | 0.3 | 0.2 | 0.1 | 0.2 | 0.2 |
| | bending(mm) | | | | | | |

As shown in Table 9, a PDP employing a rear plate according to the present invention shows improvements, which include about 30% in white brightness, about 300 K in color temperature, about 30% in contrast, about 45% in voltage margin, and about 25% in PDP efficiency, in comparison with a PDP employing a conventional rear plate. Further, power consumption is reduced about 10%, and noise is reduced about 25%.

### INDUSTRIAL APPLICABILITY

As can be seen from the foregoing, in a rear plate of a plasma display panel according to the present invention, barrier ribs are formed through etching after backing, and thus the completed barrier ribs are not deformed. Therefore, each electrode can be exactly located on a central portion between barrier ribs.

Further, when a PDP having front and rear plates attached to each other has been completed, optical characteristics of the PDP such as white brightness, color temperature, and contrast, and electric characteristics of the PDP such as voltage margin, power consumption, and electric efficiency, are improved, so that the reliability is improved.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A rear plate of a plasma display panel, the rear plate comprising:
a glass substrate;
electrodes formed in a shape of patterns on an upper surface of the glass substrate;
a dielectric layer formed on upper surfaces of the electrode and the upper surface of the glass substrate;
barrier ribs formed in a shape of a pattern through etching on an upper surface of the dielectric layer; and
phosphorous layers formed on side surfaces and bottom surfaces of the barrier ribs and including red, green, and blue phosphorous layers, which emit red, green, and blue light according to an electric signal, respectively, wherein:
the electrodes are made from mixture of a conductive metal powder of 51 to 99.5 wt % and a first glass powder of 0.5 to 49 wt %, the conductive metal powder being at least one kind of metal powder selected from metal powder of An, Ag, Pt, Pd, Ni, and Cu, the conductive metal powder having an average particle diameter of 0.1 to 7 μm, the first glass powder having an average particle diameter of 0.5 to 10 μm and a specific resistance of 1.0×10⁻⁶ to 5.0×10⁻⁶ Ωcm;
the dielectric layer is made from mixture of a first filler and at least one glass powder selected from among a second glass powder and a third glass powder, the second glass powder including PbO of 30 to 80 wt %, ZnO of 0 to 20 wt %, SiO₂ of 0 to 20 wt %, B₂O₃ of 5 to 40 wt %, Al₂O₃ of 0 to 12 wt %, Na₂O+K₂O+Li₂O of 0 to 5 wt %, and BaO+CaO+MgO+SrO of 0 to 5 wt %, the third glass powder including Bi₂O₃ of 36 to 84 wt %, B₂O₃ of 5 to 28 wt %, PbO of 0 to 46 wt %, ZnO of 0 to 30 wt %, Al₂O₃ of 0 to 13 wt %, SiO₂ of 0 to 10 wt %, Na₂O+K₂O+Li₂O of 0 to 5 wt %, and BaO+CaO+MgO+SrO of 0 to 3 wt %, each of the second and third glass powders having an average particle diameter of 0.5 to 10 μm, a softening temperature of 390 to 550° C., a thermal expansive coefficient of 63×10⁻⁷ to 83×10⁻⁷/° C., a dielectric constant of 11 to 26, and an etching rate of 0.1 to 1.0 μm/min, the first filler having an average particle diameter of 0.5 to 10 μm and including at least one oxide selected from the group consisting of TiO₂, ZrO₂, ZnO, Al₂O₃, BN, SiO₂, and MgO, which are white oxides, a ratio of volume of the first filler with respect to volume of the glass powder in the dielectric layer being 0.05 to 0.30, thereby the dielectric layer having a dielectric constant of 11 to 26, a reflectance of 50 to 80%, an etching rate of 0.1 to 1.0 μm/min, and a porosity of 5, when the dielectric layer has been baked for 10 to 60 minutes at 450 to 600° C.;
the barrier ribs are made from mixture which includes at least one glass powder selected from the group consisting of a fourth, fifth, and sixth glass powders and at least one filler selected from the group consisting of a second filler and a third filler, the fourth glass powder including ZnO of 0 to 48 wt %, SiO₂ of 0 to 21 wt %, B₂O₃ of 25 to 56 wt %, Al₂O₃ of 0 to 12 wt %, Na₂O+K₂O+Li₂O of 0 to 38 wt %, and BaO+CaO+MgO+SrO of 0 to 15 wt %, the fifth glass powder including PbO of 25 to 65 wt %, ZnO of 0 to 35 wt %, SiO₂ of 0 to 26 wt %, B₂O₃ of 5 to 30 wt %, Al₂O₃+SnO₂ of 0 to 13 wt %, Na₂O+K₂O+Li₂O of 0 to 19 wt %, BaO of 0 to 26 wt %, and CaO+MgO+SrO of 0 to 13 wt %, the sixth glass powder including PbO of 35 to 55 wt %, B₂O₃ of 18 to 25 wt %, ZnO of 0 to 35 wt %, BaO of 0 to 16 wt %, SiO₂+Al₂O₃+SnO₂ of 0 to 9 wt %, CoO+CuO+MnO₂+Fe₂O₃ of 0 to 15 wt %, Na₂O+K₂O+Li₂O of 0 to 19 wt %, and CaO+MgO+SrO of 0 to 13 wt %, each of the fourth, fifth, and sixth glass powders having an average particle diameter of 0.5 to 10 μm, a softening temperature of 390 to 630° C., a thermal expansive coefficient of 63×10⁻⁷ to 83×10⁻⁷/° C., a dielectric constant of 5 to 20, and an etching rate of 2.0 to 50.0 μm/min, the second filler including at least two oxides selected from the group consisting of NiO, Fe₂O₃, CrO, MnO₂, CuO, Al₂O₃, and SiO₂, which have dark colors, the third filler including at least one oxide selected from the group consisting of TiO₂, ZrO₂, ZnO, Al₂O₃, BN, SiO₂, and MgO, which have white colors, each of the second and third fillers having an average particle diameter of 0.1 to 10 μm, a ratio of the volume of the filler with respect to the volume of the glass powder for the barrier ribs being 0.05 to 0.67, thereby the barrier ribs having a dielectric constant of 5 to 16 and an etching rate of 2 to 50 μm/min and enabling the glass substrate having the barrier ribs to have a bending of at most 0.3 mm, when the barrier ribs have been baked for 10 to 60 minutes at 450 to 600° C., the barrier ribs having a height difference of at most 1% when the barrier ribs has been baked at 510° C. for one hour after being etched by acid-based etching solution, the barrier ribs having a destruction ratio of 50% when an iron rod, which weighs 500 g and has an end portion shaped like a sphere having a radius of 3 mm, is dropped one hundred times vertically onto uppermost surfaces of the barrier ribs from 5 mm above the uppermost surfaces, each of the barrier ribs having at least one layer; and
the red phosphorous layer includes at least two kinds of oxides selected from the group consisting of oxides Y, Gd, B, and Eu, the green phosphorous layer includes at least one kind of oxide selected from the group consisting of oxides Zn, Si, Mn, Y, B, Tb, Ba, and Al, and the blue phosphorous layer comprises at least two kinds of oxides selected from the group consisting of oxides Ba, Mg, Al, Sr, Mn, and Eu, so that, in the phosphorous layers, color temperatures are maintained between 8,000 K and 13,000 K.
